(19) United States
(12) Patent Application Publication
(10) Pub. No.: US 2003/0087030 A1
(43) Pub. Date: May 8, 2003

(54) Pet container for foods and drinks containing recycled resin and having dlc coating film formed on surface thereof

(76) Inventors: Kenichi Hama, Nishigotanda (JP); Tsuyoshi Kage, Shinagawa-ku (JP)

Correspondence Address: James V Costigan, Hedman Gibson & Costigan, Suite 2003, 1185 Avenue of the Americas, New York, NY, 10036-2601, US

(21) Appl. No.: 10/149,336

(22) PCT Filed: Dec. 26, 2000
(86) PCT No.: PCT/JP00/09267

(30) Foreign Application Priority Data
Dec. 27, 1999 (JP) 11/369414

(51) Int. Cl. B05D 1/00; B32B 1/02

(52) U.S. Cl. 427/209; 428/35.7

(57) ABSTRACT

A PET container for foods and drinks having a DLC coating film formed on the inner surface thereof, characterized in that the PET container for foods and drinks is produced by the use of a molding material comprising a mixture of a recycled resin which is originated from a used PET container for foods and drinks and has not subjected to a treatment for adjusting its intrinsic viscosity with a fresh PET resin. The above PET container for foods and drinks can provide satisfactory barrier properties against a pollutant substance being present in a resin.

### TECHNICAL FIELD

The present invention is related to a plastic container adapted for use as a food container or the like, and in particular to a plastic container containing recycled PET resin which makes it possible for the resin of a used PET (polyethylene terephthalate) container for foods and beverages to be recycled and used again as a plastic container for foods and beverages, and a manufacturing method thereof.

### PRIOR ART TECHNOLOGY

Japanese Laid-Open Patent Publication No. HEI 8-53117 discloses a vapor deposition apparatus which uses CVD (Chemical Vapor Deposition, chemical vapor growing method), in particular, a plasma CVD method to vapor deposit a DLC (Diamond Like Carbon) film on the inner surface of a plastic container in order to improve the gas barrier properties and the like of containers such as containers for carbonated beverages and high fruit juice beverages and the like. Further, Japanese Laid-Open Patent Publication No. HEI 10-258825 discloses a manufacturing apparatus for mass producing a DLC film coated plastic container, and a manufacturing method thereof. Furthermore, Japanese Laid-Open Patent Publication No. HEI 10-226884 discloses a manufacturing apparatus which makes it possible to apply a coating of DLC film without mottling to a container having protrusions which protrude from the outer surface to the outside, and a manufacturing method thereof.

A DLC film is a film called an i-carbon film or an amorphous carbon hydride film (a-C:H), and also includes a hard carbon film. Further, a DLC film is an amorphous-state carbon film, and includes SP³ bonding and Sp² bonding.

Incidentally, the estimated resource recycling rate of PET containers in Japan for 1999 was 18%, and the use thereof was 70% for fiber products, and 20% for sheet related products used for trays and egg packs and the like for packaging apples and pears and the like. These fiber products and sheet related products have a low added value, and the resource recycling rate is influenced by the market conditions and the like of the fiber industry. Hereafter, the PET container recycling rate is expected to improve in view of the building of a recycling society, and there is a demand for fundamental users of PET container recycled products. For this reason, there is a desire to use PET containers in related industries, namely, to build a bottle-to-bottle self-complete type recycling system to carry out recycling of containers.

### SUMMARY OF THE INVENTION

However, in the case where a used PET container is recycled and used again as a food container, the recycled product is required to have no problem in point of the sanitary safety of food, and even when it is assumed that the sanitary safety of a recycled product is the same as that of a new product, the consumer or user of the recycled product needs to be convinced. Further, with regard to the recycled product having no problem in point of sanitary safety of food, the approval and the like of a related government agency including an evaluation method thereof are required. Accordingly, at the present time, the use of recycled products for food containers is in a uneasy state.

A more detailed examination of the thought process of sanitary safety when recycled PET containers are used for food container packages is described below. Namely, in general after a food container package is consumed/used for the original purpose, due to contact with a foreign substance and foreign substance mixing and the like in the use for another purpose, unexpected misuse, or discarding/recycling process, a risk of contamination is expected due to the unknown substance. Accordingly, in order for it to be possible for a container to be recycled and used again as a food container package, such unknown contaminants inside the recycled product must be reduced by the recycling process to a level that makes it possible to ensure sanitary safety, namely, below the allowable reference value of contamination. In order to make it easy for the unknown contaminants to be reduced below the allowable reference value, \mathring{1} the discarding source of the reclaimed/recycled waste plastic needs to be restricted as much as possible, and the origin thereof needs to be made clear (source restricting) in order to prevent as much as possible the waste plastic that forms the source material from being contaminated by unknown substances; \mathring{2} a method of use needs to be devised to make it possible to ensure a safe level at the time of use even when, for example, some contaminants remain after recycling; \mathring{3} a recycling performance needs to be provided to make it possible to wash/reduce contaminants to a safe level even when contamination occurs due to some kind of unknown contaminants (ensuring recycling performance); \mathring{4} a means needs to be conceived to prevent contaminants from eluting into the contents even when a small amount of unknown contaminants remain; and the like need to be carried out.

With regard to \mathring{1} described above, this is a problem solved by the building of a societal recycling system, and with regard to \mathring{2}, a solution is carried out by restricting the method of use from the viewpoint of the type of foods, the use temperature, the use time, the contact surface area, the use and the like. With regard to \mathring{3}, a method has been proposed in which used resin is first decomposed to a low molecular level, and then polymerization is carried out again to form a resin.

However, with regard to the system of \mathring{1}, it is built at the same time recycled products flow to market, and with regard to \mathring{2}, it is difficult to find fundamental users of recycled products as restrictions are made to use. With regard to \mathring{3}, the required cost for the process of low molecular conversion of resin is high, and becomes disadvantageous by a cost comparison with new resin. Accordingly, the \mathring{4} conception of a means to prevent contaminants from eluting into the contents even when a small amount of unknown contaminants remain is thought to be realistic.

The means for preventing contaminants from eluting into the contents is largely separated into two kinds. As for one of these, for example, by sandwiching both surfaces of a recycled PET resin layer between new PET resin layers to create a laminated structure, the contents are prevented from making direct contact with the recycled PET resin layer, and this forms a method for preventing the movement of contaminants. The other means is a method in which, after a container is molded from only a base substance which contains recycled PET resin, the inner wall surface of the container which makes contact with the contents is coated or the like with a barrier layer that prevents the permeation of contaminants. The former means is disadvantageous because a high cost is required for molding.

The present invention is related to technology for forming the latter barrier layer which does not have a high cost, and because contaminants will elute into the container contents in a container that is obtained by simply molding resin containing recycled PET resin, it is an object thereof to make it possible to reuse used PET containers for foods and beverages by coating the inner surface of the containers with a DLC film to provide the containers with contaminant elution barrier properties, and by making it possible to reuse PET containers, placing the resin of used PET containers for foods and beverages in a recycling route. Additionally, it is an object of the present invention to reuse the resin of used PET containers for foods and beverages without requiring excessive cost, namely, without carrying out a solid phase polymerization process on the resin of used PET containers.

It is a second object of the present invention to provide a DLC film coated PET container for foods and beverages containing recycled resin having an optimal compounding ratio, with consideration given to the balance between the utilization factor of used PET containers for foods and beverages and the performance of PET containers for foods and beverages containing recycled resin. The background for considering balance comes from the following facts: \mathring{1} if the resin of a used PET container for foods and beverages which does not undergo a solid phase polymerization process has an excessive compounding ratio, it will be difficult to maintain the container strength and ensure moldability; and \mathring{2} there is a demand to minimize the effects of colored impurities contained in the resin of used PET containers for foods and beverages.

It is a third object of the present invention to provide a PET container for foods and beverages containing recycled resin coated with a DLC film having sufficient contaminant elution barrier properties and satisfactory fundamental container properties such as gas barrier properties and the like.

It is a fourth object of the present invention to provide a method of manufacturing DLC film coated PET containers for foods and beverages containing recycled resin having sufficient container strength and sufficient contaminant elution barrier properties, in which inexpensive pelletized material is used without carrying out a solid phase polymerization process on the resin of used PET containers for foods and beverages, and sufficient mixing with unused PET resin pellets is carried out to make it possible to mold containers.

Further, the container according to the present invention includes containers used with a cover or plug or seal, and also containers used in an open state without the use of such sealing members. The size of the opening is determined in accordance with the contents. Plastic containers include plastic containers having a prescribed thickness and moderate stiffness, and plastic containers formed from sheet material which is not stiff. Further, this includes the cover of the container. The contents of the plastic container according to the present invention particularly concern beverages such as carbonated beverages or fruit juice beverages or soft drinks or the like.

In order to achieve the objects described above, the present inventor discovered the following inventions. Namely, in the DLC film coated PET container for foods and beverages containing recycled resin of the present invention, a DLC film is formed on the inner surface of the PET container for foods and beverages, wherein the PET container for foods and beverages is a container molded from a molding material comprising a mixture of recycled resin of used PET containers for foods and beverages which has not undergone intrinsic viscosity adjustment, and unused PET resin.

Further, in the DLC film coated PET container for foods and beverages containing recycled resin of the present invention, the compounding ratio (weight of recycled resin of used PET containers for foods and beverages which has not undergone intrinsic viscosity adjustment/(weight of recycled resin of used PET containers for foods and beverages which has not undergone intrinsic viscosity adjustment+weight of unused PET resin)) of said mixture is preferably greater than 0 but less than 0.40.

Furthermore, in the DLC film coated PET container for foods and beverages containing recycled resin of the present invention, the oxygen permeability is preferably less than or equal to 0.010 ml/day/container when converted to a 500 ml volume.

The method of manufacturing a DLC film coated PET container for foods and beverages containing recycled resin according to the present invention comprises the steps of shredding used PET containers for foods and beverages to form flakes, and after removing foreign material from said flakes, washing said flakes using an alkaline washing agent and water, and drying said flakes to obtain washed flakes; obtaining recycled resin pellets which have not undergone intrinsic viscosity adjustment from said washed flakes; molding a container containing recycled resin using said recycled resin pellets and unused PET resin pellets adjusted so that the compounding ratio (weight of recycled resin pellets/(weight of recycled resin pellets+weight of unused PET resin pellets)) is greater than 0 but less than 0.40; and coating the inner surface of said container with a DLC film so that the oxygen permeability of said container is less than or equal to 0.010 ml/day/container when converted to a 500 ml volume.

The plastic container according to the present invention means a PET container for foods and beverages, and in particular a PET container for foods and beverages containing recycled resin. The method of manufacturing this PET container for foods and beverages containing recycled resin is as follows. Used PET containers for foods and beverages are shredded to form fine flakes, foreign material is removed, and then the flakes are washed until clean using an alkaline washing agent and water. These washed and dried flakes are pelletized by a pelletizer. These pellets of the used PET resin for foods and drinks pelletized in this way are mixed with unused PET resin, and a container is manufactured using a molder. At the container molding time, the compounding ratio (weight of recycled resin of used PET containers for foods and beverages which has not undergone intrinsic viscosity adjustment/(weight of recycled resin of used PET containers for foods and beverages which has not undergone intrinsic viscosity adjustment+weight of unused PET resin)) of these pellets should be greater than 0 but less than 0.40, and preferably greater than 0 but less than or equal to 0.30. The utilization factor of used PET for foods and beverages is preferably high, and the performance of the PET container for foods and drinks containing recycled resin is also preferably high, but when considering a balance of both of these, the most preferred compounding ratio is greater than or equal to 0.10 but less than or equal to 0.20. When the compounding ratio is 0, it is not possible to recycle used PET container resin. On the other hand, because the intrinsic viscosity (IV) of the pellets of the used PET resin for foods and beverages is low in comparison with the intrinsic viscosity of unused PET pellets, when the compounding ratio is greater than or equal to 0.40, the container strength goes down, and when an excessive amount of low intrinsic viscosity PET pellets are mixed in, it is difficult to mold PET containers. In such case, by carrying out solid phase polymerization to raise the polymerization degree of the pellets of the used PET resin for foods and beverages, and by adjusting the molecular weight of the used PET resin for foods and beverages, it is possible for a container to use 100% used PET resin for foods and beverages. However, because a rise in manufacturing costs accompanies the carrying out of solid phase polymerization, container molding is preferably carried out by mixing used PET resin which has not undergone intrinsic viscosity adjustment and unused PET resin.

Further, the transparency/clearness of the PET container for foods and beverages containing recycled resin is lowered by colored impurities contained in the pellets of the used PET resin for foods and beverages. When an overall judgment of the above facts is made, the maximum compounding ratio should preferably not exceed 0.40.

As is understood by referring to the embodiments described below, in the PET container for foods and beverages containing recycled resin obtained in this way, one portion of contaminants contained in the pellets of the used PET resin for foods and beverages will elute into the container contents. Accordingly, PET containers for foods and beverages containing recycled resin can not be reused for foods and beverages in a state where only molding is carried out.

In this regard, in the present invention, the inner surface of the container is coated with a DLC film to prevent elution of contaminants. The reason for choosing a DLC film is that a DLC film has superior performance in following the expansion and contraction of the container when compared with a SiOₓ film or the like, and in particular this choice is due to the consideration given to the case where the container is filled with beer, carbonated beverages, fruit juices or the like which cause large expansion and contraction of the container. Further, properties such as gas barrier properties and the like are changed by the composition and film thickness and the like of the DLC film. Accordingly, in the present invention, the judgment of whether or not the DLC film has sufficient contaminant elution barrier properties is determined by indicating the oxygen gas barrier properties of the entire container, and the oxygen permeability of the DLC film coated PET container for foods and beverages containing recycled resin is indicated as being less than or equal to 0.010 ml/day/container when converted to a 500 ml volume. In order to more completely prevent elution of contaminants, it is more preferred that the oxygen permeability be less than or equal to 0.005 ml/day/container when converted to a 500 ml volume. In order to make the oxygen permeability less than or equal to 0.01 0 ml/day/container when converted to a 500 ml volume, the characteristics of the DLC film such as the composition and film thickness and the like may be appropriately adjusted. However, in any case, if the oxygen permeability is not made less than or equal to 0.010 ml/day/container when converted to a 500 ml volume, the container will not have sufficient contaminant elution barrier properties.

In accordance with the invention described in claim 1, by coating the inner surface of the container with a DLC film to give the container contaminant elution barrier properties, it is possible to reuse used PET containers for foods and beverages. Further, in accordance with the reuse of PET containers becoming possible, the resin of used PET containers for foods and beverages can be placed in a recycling route. Additionally, the resin of used PET containers for foods and beverages is reused without requiring excessive costs, namely, without carrying out a solid phase polymerization process on the resin of used PET containers.

In accordance with the invention described in claim 2, \mathring{1} the resin of used PET containers which has not undergone intrinsic viscosity adjustment is used in a range that does not make it difficult to maintain container strength and ensure moldability, and \mathring{2} the effects of colored impurities contained in the resin of used PET containers for foods and beverages is minimized, and by considering the balance between the utilization factor of used PET for foods and beverages and the performance of PET containers for foods and beverages containing recycled resin, it is possible to provide a DLC film coated PET container for foods and beverages containing recycled resin having an optimum compounding ratio.

In accordance with the invention described in claim 3, it is possible to provide a DLC film coated PET container for foods and beverages containing recycled resin which has sufficient contaminant elution barrier properties, and which has sufficient fundamental container properties such as gas barrier properties and the like.

In accordance with the invention described in claim 4, it is possible to provide a method of manufacturing a DLC film coated PET container for foods and beverages containing recycled resin which has sufficient container strength and sufficient contaminant elution barrier properties, wherein a sufficient amount of unused PET resin pellets is mixed in to make it possible to mold a container using inexpensive pelletized resin of used PET containers for foods and beverages which has not undergone a solid phase polymerization process.

### BRIEF DESCRIPTION OF THE DRAWINGS

FIG. 1 is a drawing showing one example of a manufacturing apparatus for manufacturing a plastic container of the present invention.

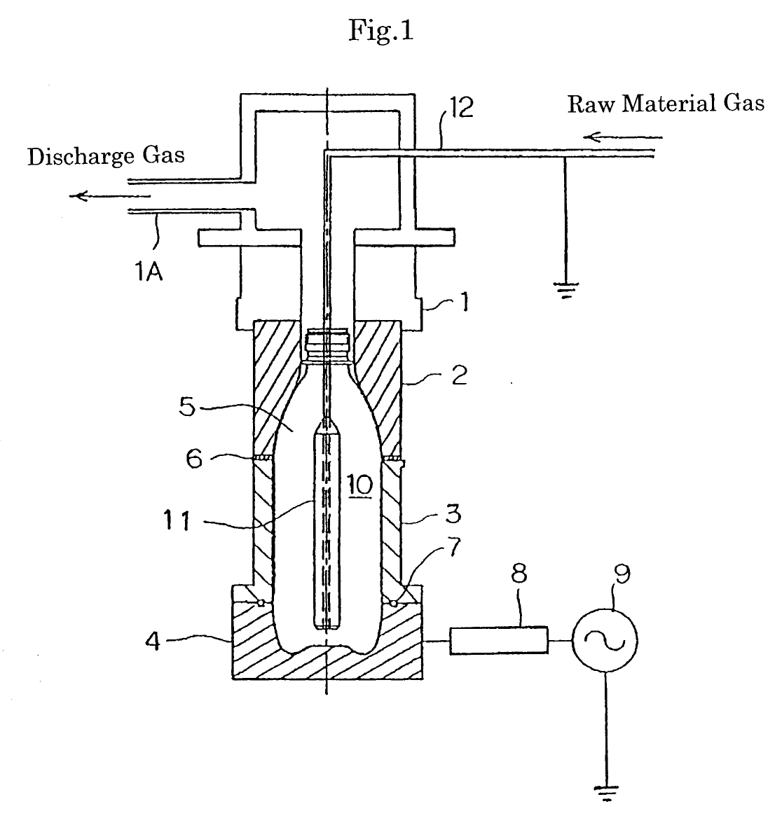

The applied symbols in FIG. 1 are as follows: 1 is a base, 1A is an exhaust outlet, 2 is a shoulder portion electrode, 3 is a body portion electrode, 4 is a bottom portion electrode, 5 is a plastic container, 6 is an insulator, 7 is an O-ring, 8 is an interface device, 9 is a high-frequency oscillator, 10 is a housing portion, 11 is an inner electrode, and 12 is a pipeline.

### PREFERRED EMBODIMENTS OF THE INVENTION

Hereinbelow, a description will be given for the preferred embodiments of a plastic container in which a DLC film is formed of the present invention.

FIG. 1 is a drawing showing one example of a manufacturing apparatus for forming a DLC film on the inner surface of a plastic container. As shown in FIG. 1, the present apparatus is equipped with a base 1, a shoulder portion electrode 2 and a body portion electrode 3 mounted to the base 1, and a bottom portion electrode 4 which can be connected to and disconnected from the body portion electrode 3. Further, the bottom portion electrode 4 isn't an electrode for only the bottom portion of the plastic container, and also functions as an electrode at the side portion of the lower portion of the body. As shown in FIG. 1, the shoulder portion electrode 2, the body portion electrode 3 and the bottom portion electrode 4 each have inner wall surfaces shaped like the outer shape of a plastic container 5, in which the shoulder portion electrode 2 is arranged along the shoulder portion of the plastic container 5, the body portion electrode 3 is arranged along the body portion of the plastic container 5, and the bottom portion electrode 4 is arranged along the bottom portion of the plastic container 5. The shoulder portion electrode 2, the body portion electrode 3 and the bottom portion electrode 4 form the outer electrodes of the present apparatus.

When the bottom portion electrode 4 is mounted to the body portion electrode 3, the base 1, the shoulder portion electrode 2, the body portion electrode 3 and the bottom portion electrode 4 form a mutually airtight mounted state, and these function as a vacuum chamber equipped with a housing portion 10 for housing the plastic container 5. As shown in FIG. 1, an insulator 6 is provided between the shoulder portion electrode 2 and the body portion electrode 3, and in this way the shoulder portion electrode 2 and the body portion electrode 3 are electrically insulated from each other. Further, an O-ring 7 is provided between the body portion electrode 3 and the bottom portion electrode 4, and when the bottom portion electrode 4 is mounted, a small gap is formed between the bottom portion electrode 4 and the body portion electrode 3. In this way, while ensuring airtightness between the bottom portion electrode 4 and the body portion electrode 3, electrical insulation is carried out between both electrodes.

An inner electrode 11 is provided in the housing portion 10, and the inner electrode 11 is inserted into the inside of the plastic container 5 housed inside the housing portion 10. The inner electrode 11 is electrically connected to a ground potential.

The inner electrode 11 is formed to have a hollow shape (tube shape), and one blowout hole (not shown in the drawing) which communicates the inside and the outside of the inner electrode 11 is formed in the lower end thereof. Further, instead of providing a blowout hole in the lower end, a plurality of blowout holes (not shown in the drawing) may be formed to pass through the inside and the outside of the inner electrode 11 in the radial direction. A pipeline 12 which communicates with the inside of the inner electrode 11 is connected to the inner electrode 11, and this structure makes it possible for a source gas fed into the inside of the inner electrode 11 via the pipeline 12 to be emitted into the inside of the plastic container 5 via the blowout hole. Further, the pipeline 12 is made of metal and has electrical conductivity, and as shown in FIG. 1, the pipeline 12 is used to connect the inner electrode 11 to a ground potential. Further, the inner electrode 11 is supported by the pipeline 12.

As shown in FIG. 1, the output terminal of a high-frequency oscillator 9 is connected to the bottom portion electrode 4 via an interface device 8. The high-frequency oscillator 9 generates a high-frequency voltage between itself and the ground potential, and in this way a high-frequency voltage is applied between the inner electrode 11 and the bottom portion electrode 4.

Next, a description will be given for the process when a DLC film is formed on the inner surface of the plastic container 5 using the present apparatus.

The plastic container 5 is set so that the bottom portion thereof makes contact with the inner surface of the bottom portion electrode 4, and by raising the bottom portion electrode 4, the plastic container 5 is housed in the housing portion 10. At this time, the inner electrode 11 provided in the housing portion 10 is inserted inside the plastic container 5 through the orifice (upper end opening) of the plastic container 5.

When the bottom portion electrode 4 is raised to a prescribed position to hermetically seal the housing portion 10, a state is formed in which the outer periphery of the plastic container 5 makes contact with the inner surfaces of the shoulder portion electrode 2, the body portion electrode 3 and the bottom portion electrode 4. Next, the air inside the housing portion 10 is exhausted through an exhaust outlet 1A of the base 1 by a vacuum device not shown in the drawing. After the pressure inside the housing portion 10 has been reduced to a required vacuum level, a source gas (e.g., carbon source gases such as aliphatic hydrocarbons such as acetylene and the like, aromatic hydrocarbons and the like, and hydrocarbon gases containing Si) supplied via the pipeline 12 is introduced into the inside of the PET container 5 from the blowout hole of the inner electrode 11.

After the concentration of the source gas reaches a prescribed value, the high-frequency oscillator 9 (e.g., 13.56 MHz) is activated to apply a high-frequency voltage between the inner electrode 11 and the outer electrodes, whereby a plasma is generated inside the plastic container 5. In this way, a DLC film is formed on the inner surface of the plastic container 5.

Namely, the formation of a DLC film on the inner surface of the plastic container 5 is carried out by a plasma CVD method, wherein electrons accumulate on the inner wall surfaces of the outer electrodes insulated by the plasma generated between the outer electrodes and the inner electrode 11, and a prescribed fall in potential occurs.

In this way, the carbon and the hydrogen of the hydrocarbon that forms the source gas present in the plasma are each ionized to positive, and these ion randomly with the inner wall surface of the plastic container 5 running along the inner wall surfaces of the outer electrodes, whereby an extremely fine DLC film is formed on the inner wall surface of the plastic container 5 by the bonding between adjacent carbon atoms and the bonding between carbon atoms and hydrogen atoms, and by the breaking of bonds of hydrogen atoms that have bonded once (sputtering effect).

As described above, the output terminal of the high-frequency oscillator 9 is connected to only the bottom portion electrode 4. Further, a gap is formed between the bottom portion electrode 4 and the body portion electrode 3, and the bottom portion electrode 4 and the body portion electrode 3 are electrically insulated from each other. Furthermore, the insulator 6 is provided between the body portion electrode 3 and the shoulder portion electrode 2, and the body portion electrode 3 and the shoulder portion electrode 2 are electrically insulated from each other. Accordingly, the high-frequency electric power applied to the body portion electrode 3 and the shoulder portion electrode 2 becomes smaller than the high-frequency electric power applied to the bottom portion electrode 4. However, because capacity coupling is carried out through the respective gaps between the bottom portion electrode 4 and the body portion electrode 3, and between the body portion electrode 3 and the shoulder portion electrode 2, a certain degree of high-frequency electric power is also applied to the body portion electrode 3 and the shoulder portion electrode 2.

In general, the bottom portion of plastic containers such as bottles and the like have complex shapes, and it is difficult to form a DLC film having sufficient thickness. Further, because the bottom portion has insufficient drawing at the time of manufacturing, the gas barrier properties of the plastic itself become lower at the bottom portion. For this reason, even after the DLC film is formed, the gas barrier properties of the bottom portion of the container are prone to lowering. However, by means of the manufacturing apparatus shown in FIG. 1, because it is possible to apply high-frequency electric power larger than that for the body portion and shoulder portion to the bottom portion of the plastic container, it is possible to form a DLC film having a uniform thickness for the entire container, and it is possible to form a thicker DLC film at the bottom portion where the gas barrier properties of the plastic itself are low. Accordingly, it is possible to effectively improve the gas barrier properties for the entire container. In the embodiment described above, it is possible to raise the applied electric power to 1200˜1400W for example, and accordingly it is possible to plan a reduction in manufacturing costs due to the shortening of the coating time.

In the apparatus described above, the shoulder portion electrode 2, the body portion electrode 3 and the bottom portion electrode 4 are constructed so as to be completely insulated against direct current, but it is also possible to connect each of the electrodes to each other by resistance or capacitive elements or the like. In short, so long as it is possible to apply high-frequency electric power having a required strength in accordance with each portion of the container, for example, a plurality of high-frequency oscillators may be provided to apply high-frequency electric power separately to each of the electrodes of the shoulder portion electrode 2, the body portion electrode 3 and the bottom portion electrode 4, or the output of a single high-frequency oscillator may be connected to each of the electrodes via a plurality of interface devices.

Further, in the apparatus described above, an example was described for the case where the outer electrodes are divided into three portions, but the outer electrodes may be divided into two portions, or the outer electrodes may be divided into four or more portions.

The DLC film coated plastic container of the present invention can be used ideally as a returnable container, but can also be used for one-way use (i.e., the use of a disposable container which is filled with contents only one time and not recycled).

The method of manufacturing the DLC film coated plastic container is not limited to the method described above. In the embodiment described above, a plasma CVD method that uses high frequency is used, but it is also possible, for example, to use a plasma CVD method using microwaves.

### EXAMPLE EMBODIMENTS

### Example Embodiment 1

A description will be given for the results of testing the effectiveness of contaminant elution inhibition of PET containers for foods and beverages containing recycled resin.

Because used PET in the city is found in various contaminated states, model contaminants were mixed with unused PET flakes to form PET flakes contaminated with model contaminants, and pseudo used PET pellets were created, and then these pseudo used PET pellets and unused PET pellets were used to form a container which was then evaluated.

In general, the contaminants of plastic can be thought to form the following four types of substances: \mathring{1} substances which are volatile and polar; \mathring{2} substances which are volatile and nonpolar; \mathring{3} substances which are nonvolatile and nonpolar; and \mathring{4} substances which are nonvolatile and polar. In this test, \mathring{1} toluene (C₆H₅.CH₃, hydrocarbon, volatile, nonpolar), \mathring{2} chlorobenzene (C₆H₅.Cl, halogenated hydrocarbon, volatile, intermediate polarity, aggressive chemical for PET), \mathring{3} n-docosane (C₂₂H₄₆, hydrocarbon, nonvolatile, nonpolar), and \mathring{4} nonadecanol (CH₃(CH₂)₁₈OH, alcohol, nonvolatile, having polarity) were used as the model contaminants for each of the four types described above.

A. Manufacture of Pseudo Used PET Pellets

First, new PET containers were shredded to create unused PET flakes. Next, the four types of model contaminants described above were added to the unused PET flakes. Specifically, as a first mixing operation, prescribed amounts of the four types of model contaminants were mixed with 500 g of unused PET flakes to make PET flakes contaminated with the model contaminants. After that, as a second mixing operation, 500 g of the PET flakes contaminated with the model contaminants was further mixed with 4500 g of unused PET flakes to make 5000 g of a PET flake mixture contaminated with the model contaminants in which prescribed amounts of the model contaminants were mixed inside the PET. Table 1 shows the mixture amounts of the model contaminants and the PET flakes.

TABLE 1

| Model Contaminants | | | |
|---|---|---|---|
| Contamination | | PET Flakes (g) | |
| Level | Contaminants (g) | First Mixing | Second Mixing |
| Low | 1 g Each × 4 = 4 g | 500 | 4,500 |
| Concentration | | | |
| Intermediate | 3 g Each × 4 = 12 g | 500 | 4,500 |
| Concentration | | | |
| High | 10 g Each × 4 = 40 g | 500 | 4,500 |
| Concentration | | | |

As shown in Table 1, mixtures were made for the three types of concentrations of model contaminants defined as low concentration, intermediate concentration and high concentration. With respect to the 5000 g of PET flakes, 1 g of each of the model contaminants for a total of 4 g for the low concentration, 3 g of each of the model contaminants for a total of 12 g for the intermediate concentration, and 10 g of each of the model contaminants for a total of 40 g for the high concentration were ultimately present in the mixtures. In the low concentration mixture, there was 0.02 parts by weight of each of the model contaminants with respect to 100 parts by weight of the PET flakes. In the intermediate concentration mixture, there was 0.06 parts by weight of each of the model contaminants with respect to 100 parts by weight of the PET flakes. In the high concentration mixture, there was 0.20 parts by weight of each of the model contaminants with respect to 100 parts by weight of the PET flakes.

Next, these three types of PET flakes contaminated with the model contaminants at the low concentration, intermediate concentration and high concentration were held at 50° C. in a hermetically sealed container for two weeks to force the model contaminants to adsorb onto the PET flakes. Next, the PET flakes contaminated with the model contaminants were remelted by an extruder to make pseudo used PET pellets. By carrying out this remelting process, the intrinsic viscosity of the pseudo used PET pellets were lowered. In this regard, in order to raise the intrinsic viscosity of the pseudo used PET pellets, namely in order to increase the molecular weight of the pseudo used PET pellets, solid phase polymerization was carried out inside a flow of nitrogen gas under the conditions of 230° C. for three hours.

Next, in order to examine the reduction of contaminants due to the purification process, analysis of the contamination level was carried out for the PET flakes (denoted as “Flakes”) contaminated with the model contaminants, the pseudo used PET pellets (denoted as “Pellets”) and the pellets after solid phase polymerization (denoted as “After Solid Phase Polymerization”). First, 1 g samples, namely the pseudo used PET flake mixture, the pseudo used PET pellets and the compounded PET pellets were placed in 5 ml test tubes, and then 1 ml of 1,1,1,3,3,3,-hexafluoro-iso-propanol was added to each sample. The samples were held at 60° C. for 24 hours in order to expand the PET. Then, 2 ml of iso-propanol was added, and after being held at 60° C. for 24 hours, the contaminants were extracted. Next, the extracts were analyzed by a gas chromatography method using a FID detector. The gas chromatograph was a HP5890 II, and the column used a SE10-30 m-0.32 mm i.D.-0.32 μm film thickness. The measurement accuracy was 0.4 ppm, and detection was not possible below 0.4 ppm. The contamination levels are shown in Table 2.

TABLE 2

| | | Toluene | Chlorobenzene | n-Docosane | Nonadecanol |
|---|---|---|---|---|---|
| Contamination | | Volatile | Volatile | Nonvolatile | Nonvolatile |
| Level | Process | Nonpolar | Polar | Nonpolar | Polar |
| Low | Flakes | 20 | 43 | 25 | 18 |
| Concentration | Pellets | Not Detected | 2.0 | 15 | 4.3 |
| | After Solid Phase | Not Detected | Not Detected | 0.8 | 1.3 |
| | Polymerization | | | | |
| Intermediate | Flakes | 63 | 98 | 43 | 75 |
| Concentration | Pellets | Not Detected | 6.3 | 28 | 37 |
| | After Solid Phase | Not Detected | Not Detected | 1.5 | 4.0 |
| | Polymerization | | | | |
| High | Flakes | 89 | 156 | 85 | 250 |
| Concentration | Pellets | Not Detected | 9.2 | 42 | 50 |
| | After Solid Phase | Not Detected | Not Detected | 3.5 | 6.3 |
| | Polymerization | | | | |

Units: ppm

As shown in Table 2, toluene which is a volatile substance was forced out due to heating up to a temperature above the melting point (approximately 255° C.) at the time of remelting in the extruder, and could not be detected at the pelletization step. Further, chlorobenzene which is a volatile substance was forced out at the solid phase polymerization step (three hours at 230° C. in a flow of nitrogen gas), and could not be detected. The n-docosane and the nonadecanol which are nonvolatile substances remained even after solid phase polymerization.

B. Evaluation by Container Formation

Next, a description will be given for the formation of containers. While carrying out mixing to form 0.10, 0.20, 0.30, 0.40 and 0.60 compounding ratios (weight of pseudo used PET pellets/(weight of pseudo used PET pellets+weight of unused PET pellets)) of the intermediate concentration pseudo used PET pellets before the solid phase polymerization described in A and the unused PET pellets, trial contaminated PET containers (resin weight: 32 g) having a 500 ml volume were created by injection molding (this case is denoted as “I”). The molding temperature was approximately 270° C. The compounding conditions of the pellets at the container molding time are shown in Table 3.

TABLE 3

| Pellet Compounding Conditions | | | | |
|---|---|---|---|---|
| at Container Molding Time | | | | |
| | Amount | Amount | | |
| | of Added | of Added | Obtained | |
| | Pseudo | Unused | Container | Amount of Each Contaminant |
| | Used PET | PET | Molding | Added Per 5000 g of Pseudo |
| Compounding | Pellets | Pellets | Weight | Used PET Pellets |
| Ratio | (g) | (g) | (g) | (g) |
| 0.10 | 3.2 | 28.8 | 32 | 3 g Each × 4 × 0.1 = 1.2 g |
| 0.20 | 6.4 | 25.6 | 32 | 3 g Each × 4 × 0.2 = 2.4 g |
| 0.30 | 9.6 | 22.4 | 32 | 3 g Each × 4 × 0.3 = 3.6 g |
| 0.40 | 12.8 | 19.2 | 32 | 3 g Each × 4 × 0.4 = 4.8 g |
| 0.60 | 19.2 | 12.8 | 32 | 3 g Each × 4 × 0.6 = 7.2 g |

Further, these compounding ratios (weight of pseudo used PET pellets/(weight of pseudo used PET pellets+weight of unused PET pellets)) are compounding ratios that correspond to the compounding ratios (weight of recycled resin of used PET containers for foods and beverages which has not undergone intrinsic viscosity adjustment/(weight of recycled resin of used PET containers for foods and beverages which has not undergone intrinsic viscosity adjustment+weight of unused PET resin)) in the case of recycling actual used PET containers.

Next, using only the low concentration, intermediate concentration and high concentration pellets after solid phase polymerization as shown in Table 2 (this case is denoted as “II”), trial contaminated PET containers (resin weight: 32 g) having a 500 ml volume were created by injection molding.

Then, using the DLC film forming apparatus described above, a DLC film was formed on the inner wall surfaces of the contaminated PET containers created by I and II described above to create DLC film coated containers having a 500 ml volume.

As for the method of forming the DLC film, the method of applying high-frequency electric power to the bottom electrode 4 was used as an electric discharging method with acetylene used as the source gas. Namely, in the state in which the shoulder portion electrode 2, the body portion electrode 3 and the bottom portion electrode 4 are electrically insulated from each other, high-frequency electric power at 13.56 MHz was applied only to the bottom portion electrode 4. The high-frequency electric power was 1300W, the vacuum level was 0.05torr (6.66Pa), and the gas flow rate was 31 cc/min.

The average thickness of the DLC film coated containers was approximately 0.3 mm, the film thickness of the DLC film was 200˜300 Å, and the amount of oxygen permeation for an entire DLC film coated container was 0.003 ml/day/container. Further, the amount of oxygen permeation in the PET containers having the same 500 ml volume but no DLC film formed therein was 0.033 ml/day/container for an entire container.

Next, a description will be given for the contaminant elution test for the above-described “contaminated PET containers” and the “DLC film coated containers” which are contaminated PET containers coated with a DLC film.

Each of the contaminated containers and the DLC film coated containers was filled with 50 ml of 1,1,1,3,3,3,-hexafluoro-iso-propanol, and then mixing by shaking was carried out at 60° C. for 24 hours to expand the PET. Next, 100 ml of iso-propanol was added, and mixing by shaking was carried out at 60° C. for 24 hours to extract the contaminants. Then, after concentrating the 150 ml of extracted liquid to 20 ml, analysis was carried out by a gas chromatograph.

Table 4 shows the analysis results of the contaminants extracted from the contaminated containers and the DLC film coated containers for the case of I and II. Further, in Table 4, n-docosane is denoted by “D”, and nonadecanol is denoted by “N”.

TABLE 4

| | Used | | | | |
|---|---|---|---|---|---|
| | Molding | Contamination | Compounding | Contaminated | DLC Film Coated |
| Contaminant | Material | Level | Ratio | PET Container | Container |
| D | I | Intermediate | 0.10 | 50 | Not Detected |
| | | Concentration | | | |
| D | I | Intermediate | 0.20 | 97 | Not Detected |
| | | Concentration | | | |
| D | I | Intermediate | 0.30 | 120 | Not Detected |
| | | Concentration | | | |
| D | I | Intermediate | 0.40 | Moldability Δ | Moldability Δ |
| | | Concentration | | | |
| D | I | Intermediate | 0.60 | Moldability x | Moldability x |
| | | Concentration | | | |
| D | II | Low | 1.00 | 16 | Not Detected |
| | | Concentration | | | |
| D | II | Intermediate | 1.00 | 28 | Not Detected |
| | | Concentration | | | |
| D | II | High | 1.00 | 72 | Not Detected |
| | | Concentration | | | |
| N | I | Intermediate | 0.10 | 43 | Not Detected |
| | | Concentration | | | |
| N | I | Intermediate | 0.20 | 102 | Not Detected |
| | | Concentration | | | |
| N | I | Intermediate | 0.30 | 153 | Not Detected |
| | | Concentration | | | |
| N | I | Intermediate | 0.40 | Moldability Δ | Moldability Δ |
| | | Concentration | | | |
| N | I | Intermediate | 0.60 | Moldability x | Moldability x |
| | | Concentration | | | |
| N | II | Low | 1.00 | 24 | Not Detected |
| | | Concentration | | | |
| N | II | Intermediate | 1.00 | 56 | Not Detected |
| | | Concentration | | | |
| N | II | High | 1.00 | 97 | Not Detected |
| | | Concentration | | | |

Units: μg/500 ml PET Container

The detection limit was 10 μg. In the case of I, the polymerization degree of the pseudo used PET pellets went down, and the intrinsic viscosity was lowered. Accordingly, in the case of the compounding ratios 0.40 and 0.60 which contain a lot of these pseudo used PET pellets having lowered intrinsic viscosity, the container strength is not sufficient, and the container moldability is also poor. When a compounding ratio of 0.40 is not exceeded, the container will have sufficient strength, and the container moldability will also be good.

As shown in Table 4, among the cases having good container moldability, both n-docosane and nonadecanol were detected for all the contaminated PET containers. On the other hand, in the DLC film coated containers, there was no detection of either n-docosane or nonadecanol for any of the contamination levels. In this way, by forming a DLC film on the inner wall surface of PET containers, it is possible to effectively inhibit the elution of contaminants from the PET containers. Further, both toluene and chlorobenzene which are volatile substances were reduced to nondetectable levels at the contaminated PET container step as described above, and the extraction thereof from the contaminated containers and the DLC film coated containers was not detected.

From the facts given above, in the case where used PET is recycled to manufacture containers again, by carrying out solid phase polymerization to raise the polymerization degree of used PET, it is possible for containers to use 100% used PET. However, because a rise in manufacturing costs will accompany the carrying out of solid phase polymerization of used PET, preferably used PET resin which has not undergone solid phase polymerization is mixed with unused PET resin to carry out container molding, and as a more preferred state, the compounding ratio (weight of recycled resin of used PET containers for foods and beverages which has not undergone intrinsic viscosity adjustment/(weight of recycled resin of used PET containers for foods and beverages which has not undergone intrinsic viscosity adjustment+weight of unused PET resin)) should be greater than 0 but less than 0.40. Preferably, the compounding ratio should be greater than 0 but less than or equal to 0.30. When considering the utilization factor of used PET and the performance of PET containers for foods and beverages containing recycled resin, the most preferred compounding ratio is greater than or equal to 0.10 but less than or equal to 0.20.

### Example Embodiment 2

Next, with reference to the case of II of Table 4, a description will be given for the relationship between the oxygen permeability of the DLC containers and the amount of elution of the contaminants. First, using the high concentration pellets after solid phase polymerization, a contaminated PET container (Experiment Number 1, no DLC film coating) having a 500 ml volume was created, and by changing the above-described vapor deposition conditions for the inner wall surface of the contaminated PET to form a DLC film on the inner wall surfaces of contaminated PET containers, a plurality of DLC containers (Experiment Numbers 2˜9) having different oxygen permeabilities were created.

As shown in Table 5, the oxygen permeability of the contaminated PET (Experiment Number 1) in a state where a DLC film was not formed was 0.033 ml/day/container. Further, the oxygen permeabilities of the DLC containers (Experiment Numbers 2˜9) created by changing the vapor deposition conditions were respectively 0.020 ml/day/container (Experiment Number 2), 0.015 ml/day/container (Experiment Number 3), 0.012 ml/day/container (Experiment Number 4), 0.010 ml/day/container (Experiment Number 5), 0.008 ml/day/container (Experiment Number 6), 0.005 ml/day/container (Experiment Number 7), 0.003 ml/day/container (Experiment Number 8), and 0.001 ml/day/container (Experiment Number 9). Table 5 shows the results of analyzing the amount of elution of nonadecanol using the same method as that of Example Embodiment 1.

TABLE 5

| | | Oxygen | Amount of Nonadecanol |
|---|---|---|---|
| Experiment | | Permeability | Elution |
| Number | | ml/Day/Container | μg/500 ml PET Container |
| 1 | Not Having DLC Process | 0.033 | 95 |
| 2 | Having DLC Process | 0.020 | 30 |
| 3 | Having DLC Process | 0.015 | 18 |
| 4 | Having DLC Process | 0.012 | 12 |
| 5 | Having DLC Process | 0.010 | Not Detected |
| 6 | Having DLC Process | 0.008 | Not Detected |
| 7 | Having DLC Process | 0.005 | Not Detected |
| 8 | Having DLC Process | 0.003 | Not Detected |
| 9 | Having DLC Process | 0.001 | Not Detected |

As shown in Table 5, in the contaminated PET (Experiment Number 1) which was not formed with a DLC film and in the DLC film coated containers (Experiment Numbers 2˜4) which have an oxygen permeability greater than or equal to 0.012 ml/day/container, eluted nonadecanol was detected, but in the DLC film coated containers (Experiment Numbers 5˜9) which have an oxygen permeability less than or equal to 0.010 ml/day/container, nonadecanol was not detected. Accordingly, it is understood that by coating the DLC film so that the oxygen permeability in the DLC coated containers is less than or equal to 0.010 ml/day/container, it is possible to almost completely prevent elution of contaminants.

By the facts described above, in contaminated PET containers, one portion of contaminants will elute into the container contents. Accordingly, contaminated PET containers can not be reused in a state where only molding is carried out. In the present invention, the judgment of whether or not the DLC film has sufficient contaminant elution barrier properties was determined by indicating the oxygen gas barrier properties of the entire container, and when the oxygen permeability of contaminated PET containers coated with a DLC film is less than or equal to 10 ml/day/container when converted to a 500 ml volume, it was discovered that it is possible to almost completely prevent elution of contaminants. In order to more completely prevent elution of contaminants, it is more preferred that the oxygen permeability be less than or equal to 0.005 ml/day/container when converted to a 500 ml volume. In order to make the oxygen permeability less than or equal to 0.010 ml/day/container when converted to a 500 ml volume which was discovered to make such fact possible, the characteristics of the DLC film such as the composition and film thickness and the like may be appropriately adjusted. However, in any case, if the oxygen permeability is not made less than or equal to 0.010 ml/day/container when converted to a 500 ml volume, the container will not have sufficient contaminant elution barrier properties.

From Example Embodiment 1 and 2, the DLC film coated PET container for foods and beverages containing recycled resin according to the present invention is a container molded from molding material which is a mixture of resin of used PET containers for foods and beverages and unused PET resin, wherein the compounding ratio of the mixture is preferably greater than 0 but less than 0.40, and wherein the oxygen permeability of the container converted to a 500 ml PET container is preferably less than or equal to 0.010 ml/day/container.

Further, the containers having a compounding ratio less than 0.40 of the example embodiments received almost no effects from contained colored impurities at the time container molding was carried out using resin of used PET containers for foods and beverages.

1. A DLC film coated PET container for foods and beverages containing recycled resin, in which the DLC (Diamond Like Carbon) film is formed on the inner surface of the PET (polyethylene terephthalate) container for foods and beverages, wherein:
the PET container for foods and beverages is a container molded from a molding material comprising a mixture of recycled resin of used PET containers for foods and beverages which has not undergone intrinsic viscosity adjustment, and unused PET resin.

2. The DLC film coated PET container for foods and beverages containing recycled resin described in claim 1, wherein the compounding ratio (weight of recycled resin of used PET containers for foods and beverages which has not undergone intrinsic viscosity adjustment/(weight of recycled resin of used PET containers for foods and beverages which has not undergone intrinsic viscosity adjustment+weight of unused PET resin)) of said mixture is greater than 0 but less than 0.40.

3. The DLC film coated PET container for foods and beverages containing recycled resin described in claim 1 or claim 2, wherein the oxygen permeability is less than or equal to 0.010 ml/day/container when converted to a 500 ml volume.

4. A method of manufacturing a DLC film coated PET container for foods and beverages containing recycled resin, comprising the steps of:
shredding used PET containers for foods and beverages to form flakes, and then after removing foreign material from said flakes, washing said flakes using an alkaline washing agent and water, and drying said flakes to obtain washed flakes;
obtaining recycled resin pellets which have not undergone intrinsic viscosity adjustment from said washed flakes;
molding a container containing recycled resin using said recycled resin pellets and unused PET resin pellets adjusted so that the compounding ratio (weight of recycled resin pellets/(weight of recycled resin pellets+weight of unused PET resin pellets)) is greater than 0 but less than 0.40; and
coating the inner surface of said container with a DLC film so that the oxygen permeability of said container is less than or equal to 0.010 ml/day/container when converted to a 500 ml volume.
